(19) United States
(12) Patent Application Publication
(10) Pub. No.: US 2019/0337182 A1
(43) Pub. Date: Nov. 7, 2019

(54) DEVICE FOR INSERTING A FIRST RAM OR A SECOND RAM IN AN ALTERNATING MANNER

(71) Applicant: BOXPLAN GMBH & CO.KG, Radolfzell (DE)

(72) Inventor: Tobias JAKOB, Radolfzell (DE)

(73) Assignee: BOXPLAN GMBH & CO.KG, Radolfzell (DE)

(21) Appl. No.: 16/475,346

(22) PCT Filed: Jan. 16, 2018
(86) PCT No.: PCT/EP2018/050918

§ 371 Date: Jul. 1, 2019

(30) Foreign Application Priority Data
Jan. 18, 2017 (DE) 10 2017 100 957.4

(51) Int. Cl. B26D 7/18

(52) U.S. Cl. CPC B26D 7/1818

(57) ABSTRACT

The invention relates to a device for inserting a first ram (1) or a second ram (2) in an alternating manner into a ram feeder (3) of a device for inserting stripping pins and stripping claws into a stripping tool, wherein the first ram (1) and the second ram (2) are mounted on a retaining plate (6) so as to be moveable in a first movement direction (4), wherein the ram feeder (3) can be moved in a second movement direction (5), and wherein the first movement direction (4) is orthogonal to the second movement direction (5).

### TECHNICAL FIELD

The invention relates to a device for inserting a first ram or a second ram in an alternating manner according to the preamble of claim 1.

### BACKGROUND ART

Various automation techniques for manufacturing a stripping tool are known and used in the background art.

In this connection reference is made to U.S. Pat. No. 5,049,122 which discloses an automation for stripping pins.

Further, reference is made to DE 297077921, which also discloses an automated method for manufacturing a stripping tool, wherein stripping pins are also used in an automated manner here.

In the same manner, reference is made to U.S. Pat. No. 5,291,652 A and DE 4103339 A1.

However, none of the citations describe an automated manufacturing method of a stripping tool, wherein not only stripping pins but also flat stripping claws are to be used.

### Object of the Invention

The object of the present invention is to overcome the disadvantages of the background art. In particular, a device is to be provided which enables an automated manufacture of a stripping tool, in which, in addition to the stripping pins, stripping claws can be set automatically and mechanically. This is to take place in such a manner that various rams can additionally be set easily and quickly with one and the same ram feeder in a space-saving manner.

### Solution of the Object

The features according to claim 1 lead to the solution of the object. Advantageous embodiments are described in the dependent claims.

A device according to the invention serves for alternately inserting a first ram or a second ram into a ram feeder. Two different rams are of advantage here, as the two rams can have different properties, in order to, for example, insert different stripping claws into the stripping tool. A corresponding quick change between the first ram and the second ram is therefore essential.

The first ram and the second ram are thereby arranged movably on a retaining plate in a first movement direction. The ram feeder is movable in a second movement direction, wherein the first movement direction is orthogonal to the second movement direction. The first movement direction and the second movement direction are also reversible. This means that each movement direction can also be reversed according to the requirements of the user.

The first ram comprises a first stripping claw head and the second ram comprises a second stripping claw head.

The first ram has a first spring and the second ram has a second spring. The two springs can serve, for example, for resetting the two rams.

The first ram and the second ram are arranged parallel to each other on a carriage. A reception is arranged on the carriage, wherein the first ram and the second ram are held in the reception. The carriage is thereby moved over two rails, which are arranged on the retaining plate. The carriage, for example, thereby has grooves, which are in operative connection with the rails and permit a defined movement of the carriage.

The ram feeder has a guide sleeve. The guide sleeve thereby serves for receiving, retaining and introducing the stripping claw into a stripping tool. For this, the guide sleeve has a stripping claw receiving slot.

Further, the carriage can be mobilized in the first movement direction by a drive. The ram feeder can also be moved in the second movement direction by a further drive. After the ram feeder has released the first stripping claw head by moving in the second movement direction, the carriage can for example be moved in the first movement direction, until the second stripping claw head is positioned in such a manner that, when moving the ram feeder back against the second movement direction, the second stripping claw head moves into the ram feeder, in order to drive a stripping claw possibly retained in the stripping claw receiving slot, for example into a wooden board for manufacturing a stripping tool. This process for the automated setting of stripping claws can be repeated any number of times.

The first movement direction and the second movement direction can respectively be moved reversibly.

### DESCRIPTION OF THE FIGURES

Further advantages, features and details of the invention will become apparent from the following description of preferred exemplary embodiments and by means of the drawings; these show in:

FIG. 1 a device according to the invention in a first position;

FIG. 2 the device according to the invention of FIG. 1 in a second position.

### EXEMPLARY EMBODIMENT

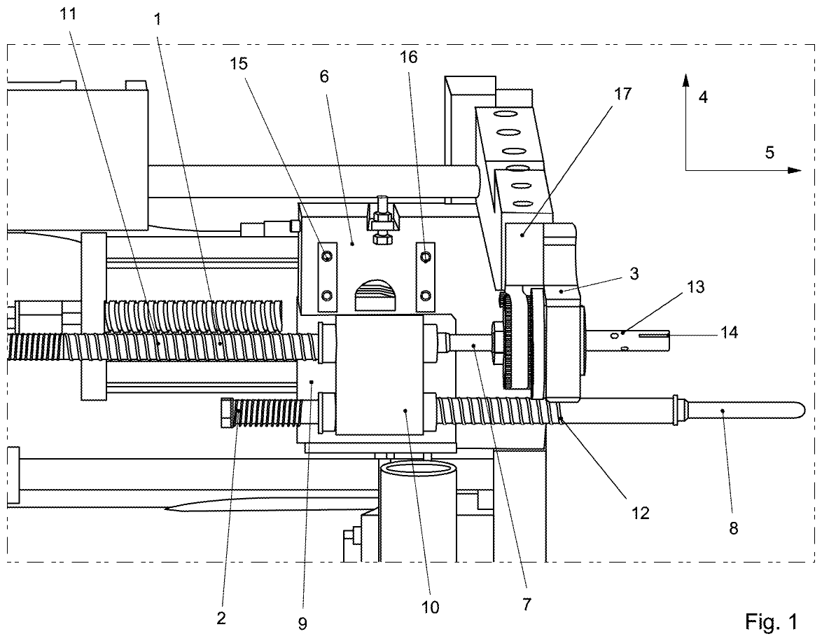

A device for alternately inserting a first ram 1 or a second ram 2 into a ram feeder 3 is shown in FIG. 1.

The first ram 1 and the second ram 2 are thereby arranged movably on a retaining plate 6 in a first movement direction 4.

For this, the retaining plate 6 has a first rail 15 and a second rail 16. On the rails 15, 16, a carriage 9 is movable, wherein the carriage 9 is present in a reception 10.

The first ram 1 and the second ram 2 are arranged parallel to each other on the carriage 9. The rams 1,2 are thereby arranged in the reception 10.

The first ram 1 comprises a first stripping claw head 7. The second ram 2 comprises a second stripping claw head 8. The first ram 1 has a first spring 11. The second ram 2 has a second spring 12. The reception 10 also serves as a stop for the springs 11, 12.

The springs 12, 13 are elastic springs, which are respectively arranged around the two rams. The spring 12 is arranged around the ram 1. The spring 13 is arranged around the ram 2.

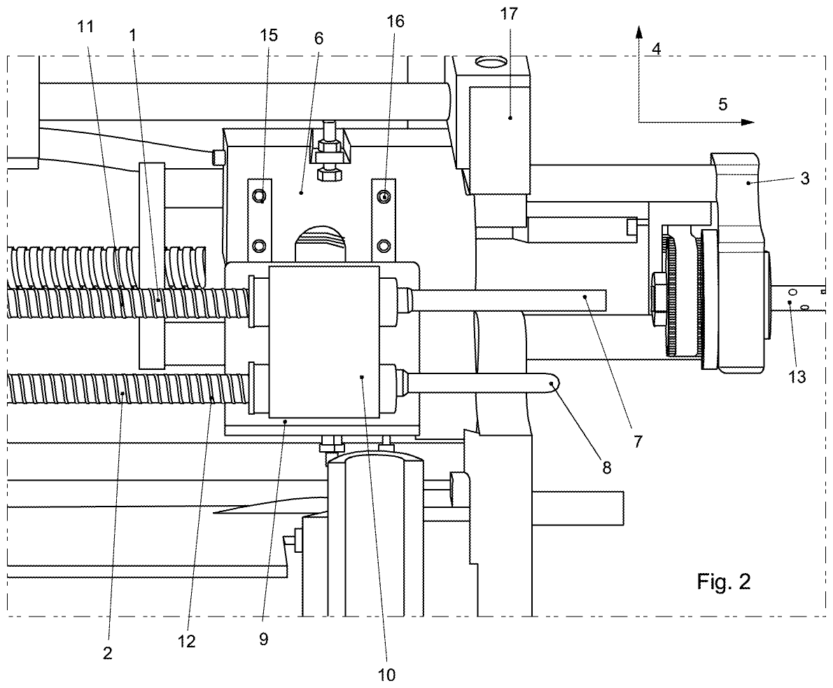

The retaining plate 6 is arranged on a function plate 17. The function plate 17 in turn serves as a stop for the ram feeder 3. FIG. 1 shows how the ram feeder 3 is moved to the function plate 17. FIG. 2 shows how the ram feeder 3 is moved away from the function plate 17 in the second movement direction 5.

The ram feeder 3 is movable in a second movement direction 5, wherein the first movement direction 4 is orthogonal to the second movement direction 5.

The ram feeder 3 has a guide sleeve 13. The guide sleeve 13 thereby has a stripping claw receiving slot 14. The stripping claw receiving slot 14 serves for the automated reception of stripping claws. For this, the ram feeder 3 is moved in the second movement direction 5. A stripping claw is thereby inserted into the stripping claw receiving slot 14.

After the ram feeder 3 is moved back against the second movement direction 5 in the direction of the function plate 17, the first stripping claw head 7 or the second stripping claw head 8 moves in the guide sleeve 13. If the second stripping claw head 8 is to be used, the carriage 9 is moved in the first movement direction 4 on the rails 15, 16.

The carriage 9 comprises a drive not shown in detail, which is movable in the first movement direction 4. Further, the ram feeder 3 can be moved in the second movement direction 5 by a further drive, also not shown.

List of reference numerals

| | |
|---|---|
| 1 | First ram |
| 2 | Second ram |
| 3 | Ram loader |
| 4 | First movement direction |
| 5 | Second movement direction |
| 6 | Retaining plate |
| 7 | First stripping claw head |
| 8 | Second stripping claw head |
| 9 | Carriage |
| 10 | Reception |
| 11 | First spring |
| 12 | Second spring |
| 13 | Guide sleeve |
| 14 | Stripping claw receiving slot |
| 15 | First rail |
| 16 | Second rail |
| 17 | Function plate |
| 18 | |
| 19 | |
| 20 | |
| 21 | |
| 22 | |
| 23 | |
| 24 | |
| 25 | |
| 26 | |
| 27 | |
| 28 | |
| 29 | |
| 30 | |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |

1. A device for alternately inserting a first ram (1) or a second ram (2) into a ram feeder (3),
characterized in that
the first ram (1) and the second ram (2) are arranged movably on a retaining plate (6) in a first movement direction (4), wherein the ram feeder (3) is movable in a second movement direction (5), wherein the first movement direction (4) is orthogonal to the second movement direction (5).

2. The device of claim 1, characterized in that the first ram (1) comprises a first stripping claw head (7) and the second ram (2) comprises a second stripping claw head (8).

3. The device of claim 1, characterized in that the first ram (1) has a first spring (11) and the second ram (2) has a second spring (12).

4. The device of claim 1, characterized in that the first ram (1) and the second ram (2) are arranged parallel to each other on a carriage (9).

5. The device of claim 4, characterized in that a reception (10) is arranged on the carriage (9), wherein the first ram (1) and the second ram (2) are held in the reception (10). The device according to claim 5, characterized in that the reception (10) serves as a stop for the first spring (11) and the second spring (12).

6. The device of claim 1, characterized in that the ram feeder (3) comprises a guide sleeve (13).

7. The device of claim 7, characterized in that the receiving slot comprises a stripping claw stop (14).

8. The device of claim 1, characterized in
that the carriage (9) can be moved in the first movement direction (4) by a drive.

9. The device of claim 1, characterized in that the ram feeder (3) can be moved in the second movement direction (5) by a further drive.

10. The device of claim 1, characterized in that the ram feeder (3) can be moved in the second movement direction (5) by a further drive.
